(19) United States
(12) Patent Application Publication
(10) Pub. No.: US 2009/0287588 A1
(43) Pub. Date: Nov. 19, 2009

(54) METHOD, A SYSTEM AND A USER INTERFACE FOR SHOPPING USING A COMMUNICATION NETWORK

(76) Inventor: Jean Ourega Dobe, Verdun (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/122,786

(22) Filed: May 19, 2008

(51) Int. Cl. G06Q 30/00; G06F 3/048

(52) U.S. Cl. 705/27; 715/764

(57) ABSTRACT

There is provided a method for enabling a user to shop with at least one other user on a data network, the method comprising providing access to a user interface enabling the user to conceive a set of at least one item of interest, to share the set with at least one other user via the data network, and to communicate with the at least one other user via the data network to thereby shop said set. There is further provided a user interface and a system for enabling a user to shop with at least one other user on a data network.

### FIELD OF THE INVENTION

This description relates to the field of electronic commerce and more particularly to a method, system and user interface for using communication networks to enable a group of consumers to share a shopping session and exchange product ideas and communications, and the ability to mix and match a variety of products using an electronic commerce application.

### BACKGROUND OF THE INVENTION

As electronic commerce evolves, the Internet is becoming a ubiquitous tool for consumers when searching and purchasing goods and services. However, most of the e-commerce operations executed on the Internet are performed in a single-user/consumer configuration. Essentially, the consumer shops on an Internet website with a shopping cart without any live interaction whatsoever.

The online consumer is not able to obtain any advice or ideas from others unless they are physically next to him/her or communicate using conventional methods (i.e. email, telephone, etc.). Moreover, the consumer cannot easily mix and match products on the same browser.

The popularity of the Internet has grown due to the fact that it increases interaction between people. For instance, the Internet enables people to interact through technologies such as e-mail, chat rooms, bulletin boards, and video-cameras.

Conventional shopping, i.e. shopping in the real world, can be seen as a form of socializing and entertainment. The consumer may go to a mall with friends, mix and match products in a fitting room, and ask for advice from friends/experts regarding a product.

There is a need for a method and apparatus that will overcome at least one of the above-identified drawbacks.

### SUMMARY OF THE INVENTION

It is therefore an object of the present invention to provide a method, a user interface and a system to enable a group of users, such as consumers, friends and/or product experts, to share a live shopping session and concurrently exchange a wide range of product information and personal opinions using electronic commerce applications. Product information can be images of the products, product descriptions, and any other information concerning products for sale.

In the specification, the verb “to shop” is intended to mean “to examine goods or services with intent to buy, to hunt in search of the best buy, to make a search, to get informed on, to examine a stock or offerings, to offer for consideration or acceptance, to offer for sale or in a trade.”

According to one aspect, there is provided a method for enabling a user to shop with at least one other user on a data network, the method comprising providing at least one item of interest in an interface displayed to the user, enabling the at least one other user to access the interface displayed to the user via the data network and interactively communicating between the user and the at least one user via the interface using the data network to thereby shop the at least one item of interest.

The user can also make a purchase decision based on the shopping experience.

According to a second aspect of the invention, there is provided a method for enabling a user to shop with at least one other user over a data network, the method comprising: providing access to a user interface enabling the user to conceive a set of at least one item of interest, to share the set with at least one other user via the data network, and to communicate with the at least one other user via the data network to thereby shop the set.

Preferably, the user interface comprises a communication interface and the enabling the user to communicate with the at least one other user comprises enabling the user to initiate an interactive communication session with the at least one other user and to interactively communicate therewith using the communication interface.

Preferably, the sharing and the communication processes are carried out concurrently by said user.

Preferably, the user interface further comprises a fitting room interface and the enabling the user to conceive a set of at least one item of interest comprises enabling the user to insert and manage the at least one item using the fitting room interface.

Preferably, the process of enabling the user to insert at least one item comprises at least one of enabling the user to select the at least one item from an electronic market database connected to the data network and enabling the user to upload the at least one item from a personal storing device connected to said data network.

Preferably, the process of enabling the user to manage the at least one item comprises at least one of enabling the user to spatially organize the at least one item within the fitting room interface and enabling the user to logically organize the at least one item using features of the fitting room interface.

The process of enabling the user to share the set with at least one other user can comprise storing data associated with the set in an item set database connected to the data network and providing the at least one other user access information allowing for accessing, via the data network, the set related data stored in the item set database.

The process of enabling the user to share the set with at least one other user can also comprise enabling the user to create a file embodying a visual representation of the set and to transmit the created file to the at least one other user via the data network.

Preferably, the communication interface is adapted to receive at least one of data input and voice input.

Preferably, the process of enabling the user to initiate an interactive communication session comprises enabling the user to transmit an invitation request to the at least one other user using the communication interface, where the communication session is automatically established upon reception of an invitation acceptance signal thereof.

Preferably, the invitation request comprises information allowing establishing a communication link between the at least one other user and the user via the data network.

As a further aspect of the invention, there is provided a user interface for enabling a user to shop with at least one other user over a data network, the user interface comprising a fitting room interface with fitting room tools for enabling the user to conceive a set of at least one item of interest and a communication interface with communication tools for enabling the user to share the set with at least one other user and to communicate therewith via the data network in order to shop the set of at least one item.

Preferably, the fitting room tools comprise an item insertion tool for enabling the user to insert the at least one item into the fitting room interface.

Preferably, the fitting room tools further comprise item management tools for enabling the user to carry out at least one of spatially organizing and logically organizing the at least one item.

Preferably, the fitting room tools further comprise a storing tool for enabling the user to store the conceived set in an item set database connected to the fitting room interface.

Preferably, the fitting room tools further comprise a send to friend tool for enabling the user to provide the at least one other user access to the set of at least one item.

Preferably, the communication tools comprise a communication session activation tool for enabling the user to initiate an interactive communication session with the at least one other user via the data network.

As another aspect of the invention, there is provided a system for enabling a user to shop with at least one other user over a data network, the system comprising:
a fitting room unit adapted to be connected to the data network for enabling the user to conceive a set of at least one item of interest via the data network; and
a user communication unit adapted to be connected to the fitting room unit and to the data network for enabling the user to share the conceived set with at least one other user and to interactively communicate therewith via the data network in order to shop the set of at least one item.

Preferably, the fitting room unit comprises:
a first input/output unit adapted to be connected to a user fitting room interface and to the data network;
an item insertion module connected to the first input/output unit and adapted to be connected to an item database for inserting the at least one item into the fitting room interface, where the inserting comprises at least one of selecting the at least one item from an electronic market database connected to the data network and uploading the at least one item from a personal storing device connected to the data network;
an item set creation module connected to the first input/output unit for receiving the at least one item of interest inserted by the user and for managing the at least one item according to user parameters defined thereby using the fitting room interface, where the managing comprises at least one of spatially organizing the at least one item within the fitting room interface and logically organizing the at least one item using features of the fitting room interface; and
a display module connected to the item creation module and to the first input/output unit for displaying the conceived set of at least one item to the user.

Preferably, the user communication unit comprises:
a second input/output unit adapted to be connected to a user communication interface and to the data network;
a guest invitation request transmitting module connected to the second input/output unit for transmitting an invitation request to each one of the at least one other user inviting to establish an interactive communication session with the user;
a guest invitation response receiving module connected to the second input/output unit for receiving a response from the at least one other user accepting or refusing the invitation; and
a communication service activation module connected to the guest invitation response receiving module and to the second input/output unit for activating an interactive communication session between the user and each one of the at least one other user having accepted the invitation.

Preferably, the fitting room unit further comprises
an item set storing module connected to the item set creation module, to the first input/output interface and to an item set database for storing the conceived set in an item set database;
an item set extraction module connected to the first input/output interface, to the display module and to the item set database for extracting thereof set related information associated with a previously stored set.

Preferably, the system further comprises:
a guest communication unit adapted to be connected to a guest communication interface and to the data network for enabling the at least one other user to receive access information associated with the conceived set of at least one item and to interactively communicate with the user via the data network in order to shop the set; and
a display module adapted to be connected to the guest communication unit and to a display interface for receiving the access information and displaying the set to the at least one other user via the display interface.

### BRIEF DESCRIPTION OF THE DRAWINGS

Further features will become apparent from the following detailed description, taken in combination with the appended drawings, in which:

FIG. 1 is a flowchart which shows an embodiment of a method for enabling a user to shop with at least one other user on a data network;

FIG. 2 is first diagram which shows a system for enabling a user to shop with at least one other user on a data network according to an embodiment;

FIG. 3 is a second diagram which shows a system for enabling a user to shop with at least one other user on a data network according to an embodiment;

FIG. 4 is a bloc diagram illustrating a first embodiment of a system for enabling a user to shop with at least one other user on a data network;

FIG. 5 is a bloc diagram illustrating an internal architecture of a fitting room unit according to one embodiment of the present invention; and

FIG. 6 is a bloc diagram illustrating an internal architecture of a user communication unit according to one embodiment of the present invention.

FIG. 7 is a bloc diagram illustrating a second embodiment of a system for enabling a user to shop with at least one other user on a data network;

It will be noted that throughout the appended drawings, like features are identified by like reference numerals.

### DESCRIPTION OF THE PREFERRED EMBODIMENT

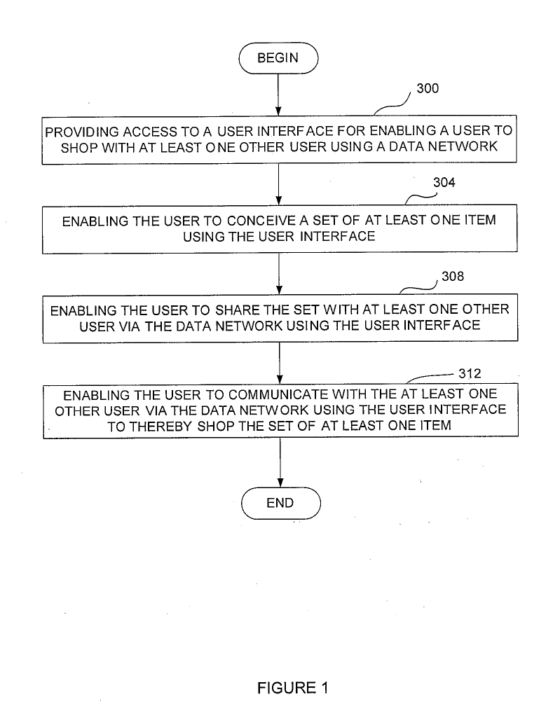

Now referring to FIG. 1, there is shown an embodiment of a method for enabling a user to shop with at least one other user on a data network.

According to step 300, there is provided access to a user interface for enabling the user to shop with at least one other user using the data network. The at least one item of interest is provided in an interface displayed to the user. In an embodiment, the user creates (or conceives) the at least one item of interest using the user interface 304. For example, a user searches and browses a web site and views an item possibly accompanied by an item description. A button or icon, such as an “Add to Live” button, is displayed on screen to enable the user to add the displayed item into a “Live Shopping Session” or a “Fitting Room”. It will be appreciated that the at least one item of interest thus created is provided in a window of the interface referred to below as a “Live Shopping Session” or a “fitting room”.

In one embodiment, the at least on item can be uploaded by the user via the data network from a personal storing device or from any electronic market database. Accordingly, the user interface further comprises a fitting room interface and the process of enabling the user to conceive a set of at least one item of interest comprises enabling the user to insert and manage the at least one item using the fitting room interface.

The process of enabling the user to manage the at least one item comprises at least one of enabling the user to spatially organize the at least one item within the fitting room interface and enabling the user to logically organize the at least one item using features of the fitting room interface.

According to step 308, the user is enabled to share the set of at least one item with the at least one other user using the user interface. In one embodiment, the process of enabling the user to share the set with at least one other user comprises storing data associated with the set in an item set database connected to the data network and providing the at least one other user access information allowing for accessing, via the data network, the set related data stored in the item set database.

In another embodiment, the process of enabling the user to share the set with at least one other user comprises enabling the user to create a file embodying a visual representation of the set and to transmit the created file to the at least one other user via the data network.

In one embodiment, the at least one other user can access the set using a guest interface connected to the data network where the guest interface is adapted to display the set. The at least one other user may include friends, relatives, product experts or any other person the user wants to invite.

According to step 312, the user is enabled to communicate with the at least one other user via the data network using the user interface to thereby shop the set of at lest one item. In a preferred embodiment, the communication is performed interactively between the user and the at least one other user using the data network. Accordingly, the user interface comprises a communication interface and the process of enabling the user to communicate with the at least one other user comprises enabling the user to initiate an interactive communication session with the at least one other user and to interactively communicate therewith using the communication interface.

In one embodiment, the process of enabling the user to initiate an interactive communication session comprises enabling the user to transmit an invitation request to the at least one other user using the communication interface, where the communication session is automatically established upon reception of an invitation acceptance signal thereof.

It should be appreciated that the invitation request comprises information allowing to establish a communication link between the at least one other user and the user via the data network.

It should be appreciated that the communication interface is adapted to receive at least one of data input and voice input.

In a preferred embodiment, the communication is performed by the user in a window of the user interface referred to below as a “chat room”. The “chat room” connects all participants. If the user invites another user who is not logged or accessing the network at the time the post is sent, the invited user will be contacted by sending an invitation by email. For example, friends/experts who are not “online” at the time the invitation is made can be notified by the email which can be received on their Mobile Phone, PDA, Blackberry or any other portable device the invited user possesses. In a preferred embodiment, the communication is performed by the at least one other user in a window of the guest interface referred to below as a “chat room”.

It will be appreciated that a user of the at least one other user may edit or modify any set of items received from the user and advise the sending user of its opinions and suggestions. It will further be appreciated that each user may further upload/link to items available on other websites, or on the user's own computer, to create new sets to be stored on the mediator's website.

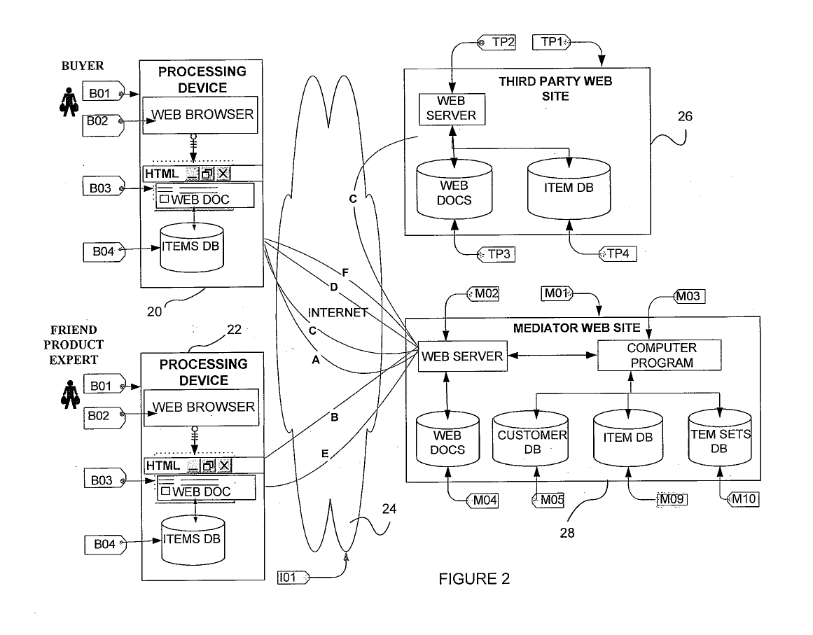

Now referring to FIG. 2, there is shown a first diagram of a system for enabling a user to shop with at least one other user on a data network.

A user, also referred to as a buyer, operating a buyer processing device 20, is connected to a mediator website 28 via a data network 24. At least one other user is connected to the mediator website 28 using a processing device 22 via the data network 24. A third party website 26 is connected to the mediator website 28 via the data network 24.

In an embodiment, the data network 24 comprises at least one of a local area network (LAN), a metropolitan area network (MAN) and a wide area network (WAN). In an embodiment, the data network 24 is the Internet.

The processing device 20 may be selected from a group consisting of desktop computers, portable computers, personal digital assistant, smart phones or any other computing devices with Web browsing capability. It will be appreciated that in the embodiment disclosed in FIG. 2, the processing device 20 comprises an item database for storing at least one item owned by the user and any other selected item, and a web browser used to navigate and to display the interface. If the item owned by the user is not available on the web site, it can be uploaded by the user in the “fitting room” user.

Similarly, the processing device 22 may be selected from a group consisting of desktop computers, portable computers, personal digital assistant, smart phones or any other computing devices with Web browsing capability. It will be appreciated that in the embodiment disclosed in FIG. 2, the processing device 22 comprises an item database for storing at least one item owned by the user and any other selected item, and a web browser used to navigate and to display the interface. The item owned by the user may not available on the web site but can be uploaded in the fitting room by the invited participant.

The mediator website 28 comprises a web server, a computer program, a customer database, an item database; an item set database and web doc database. The customer database, the item database, an the item set database are operatively connected to the computer program that powers the “Live Shopping session” while the web docs database is operatively connected to the web server. This can be implemented using other alternatives. For example, all the databases can be operatively connected to the web server or to any other processing device for running the computer program stored into its memory.

It will be appreciated that the mediator website 28 provides an electronic marketplace, i.e. a website, wherein all participants register their personal information. This website is accessible to users via the data network 24. The user may communicate through and interact through the mediator website 28 using an interface and interface software. In an embodiment, the user interface is generated using a Web browser software. The skilled addressee will appreciate that using a browser is useful in order to ensure portability to users of the data network 24. It will be further appreciated that information may be transmitted back and forth between the users and the Mediator website 28 using the interface.

In an embodiment, the method disclosed in FIG. 1 is implemented by software running on the Mediator website through which a user may enroll as a customer via an on-line registration process which may be automated in an embodiment. In an embodiment, the information is stored on the mediator website 28. The user may then browse the mediator website 28 to view what products or items are available for sale. The Mediator computer-implemented system generates the web page for the viewing of the products for sale. The consumer will be provided with a complete array of product information for assistance in finalizing a purchase. From this point, the consumer may search for and select any number of products to purchase and effect his payment using the Mediator check-out options.

Once the consumer signed in to the mediator website 28 and searched for a product, he may then choose to engage in a live shopping session. The user may add any items to the Live Shopping by clicking on the “ADD TO LIVE” button from an item view page. This operation may be performed without been signed, i.e. anonymously, on the system in an embodiment.

Chat Room:

The user uses the chat room to communicate with a fellow participant, i.e. friend/relative and/or experts, and has the opportunity to share opinions, product details, and product images with him. Other signed-in shopping guests may be added to the chat room and contribute to the live shopping session experience. Each participant is in an embodiment identified by a User ID or username. The consumer may add the signed-in guests' usernames, or User ID, in order to allow the guests to enter his chat room session. All guests may accept or refuse the invitation by clicking on the appropriate buttons. Also, guests may be removed from the live shopping session by deleting their names. A consumer may manage a list of guests in his account settings. A chat room used by the LIVE SHOPPING application has customized features. As mentioned somewhere in this document, this application can also send email notification (invitation) to participants/Guest to join the Live Shopping Session. Other chat room known in the Internet is MSN Messenger, Yahoo! Messenger, just to name a few . . . . But this invention differentiates itself from the conventional chat rooms, since it is implemented to power an e-commerce process

Fitting Room

The consumer is able to assemble, save, and manage a collection of item sets. The fitting room may be understood as being a collection of user-built items sets. Also, the consumer will be able to send product information from each item-match to signed-in fellow guests in the chat room by clicking the “SEND TO FRIENDS” button.

Item Sets

An item set may be understood as being the contents of one on-line shopping cart displayed on a layout screen to mimic a fitting room in the real world. After selecting one or more products, the consumer may save that array of products using an item set name in the Item database M09 or in the Item Set database M10 of the mediator web site 28. The contents of the item-set may be saved, changed, and/or sent to another guest consumer(s) via the chat room. If one of the signed-in fellow guests wishes to effect payment for the products in a specific item-set, he will be allowed to do so using the Mediator check-out system.

Although the consumer may upload product images from any worldwide site or his computer for comparison purposes in his item-sets, the only products he will be able to effect payment on are those found for sale on the Mediator website and/or any worldwide site affiliated with the Mediator website.

Live Shopping Companion Features

1. “Add to Live!”

Clicking the “Add to Live!” feature, available on the Mediator or affiliated website/third-party, will enable the consumer to access a live shopping session from any of the Mediator/affiliated/third-party product page permitting the consumer to share product images, product descriptions, and a sharing of opinions with other logged-in users. When this action is performed by a participant from a product page on an affiliated/third-party website, the action request is redirected to the Mediator website which runs the “Live Shopping” application

2. “Items” Field

The “Items” field located in the fitting room enables the consumer to add numerous items to a collection of products. The items may be obtained by browsing and searching through the Mediator/affiliated/third-party website. The consumer may also choose to upload an image from his personal computer or third-party website (with no “Live Shopping” functionality) by clicking on the “Upload” link located at the bottom of the fitting room.

3. Product Matrix Fields

The product matrix fields located in the fitting room enables the consumer to define a (A×B) matrix layout in order to display the selected item(s) added to the collection of products. In order to display an item from the “Items” field to a specific matrix location (i.e. ranging from #1-#N), the consumer needs only to select the item from the list and to select the appropriate numerical buttons located beneath the “Items” field (i.e. also numbered #1-#N).

4. Product Matrix Sample

An item-match may be created by the consumer by entering the item-match name of his choice in the appropriate field and clicking on the “Save as” button located to the left of the data field. The consumer may also resize each item image by selecting the “UP” or “DOWN” arrows located to the left of each image.

6. “View Choices”

Clicking the “View choices” located at the bottom of the fitting room feature will display the previously saved items, or matches, for the consumer and enable him to view items in a set, by clicking the “Display” button, or delete the items in a set by clicking the “Delete” button. Selecting the “Delete choice” button will delete the complete item match if the consumer so wishes.

8+9. “Add Guest” Field

The consumer may choose to add any number of guests to participate in his live shopping session by entering the logged-in guests' names in the “Add guest” field located at the bottom of the CHAT ROOM.

Guests may be removed from the CHAT ROOM session by using the “Delete” button at the top of menu. When sending item-matches and/or text messages to other participants, only those listed as guests by each participant will be able to view the shared posts.

10. Chat Room Sample

Review the example CHAT ROOM messages. The existing messages notify other participants that user “jdobey” has invited guest “James” to the live shopping session. Every existing participant will then be able to accept or reject “James” as a guest in their live shopping session.

11+12. “Send to Friends”

Once the consumer has selected and displayed a set of items, he may then post this selection to other participants in the CHAT ROOM by clicking on the “Send to friends” button located at the bottom of the fitting room. Please review the example with the item set named “matches2006”.

Once the data is sent, every participant will receive a message as is displayed in the chat room sample or an e-mail messaging tool. The participant may then click on the “Attachment” link in order to view the item-match which was sent. If the participant is logged on to the Mediator website, the data will be displayed in the participant's fitting room. If the participant is not logged on to the Mediator website, he will be redirected to Mediator and an automated fitting room will be created in order to display the data.

Shopping session history may be stored in a user profile to enable him to review past communications and item sets received from/sent to others.

Once the data is displayed, every active participant may then save the item-match for future reference, modify the specific items of his choice, and/or create new matches and post these changes for the other live shoppers to review.

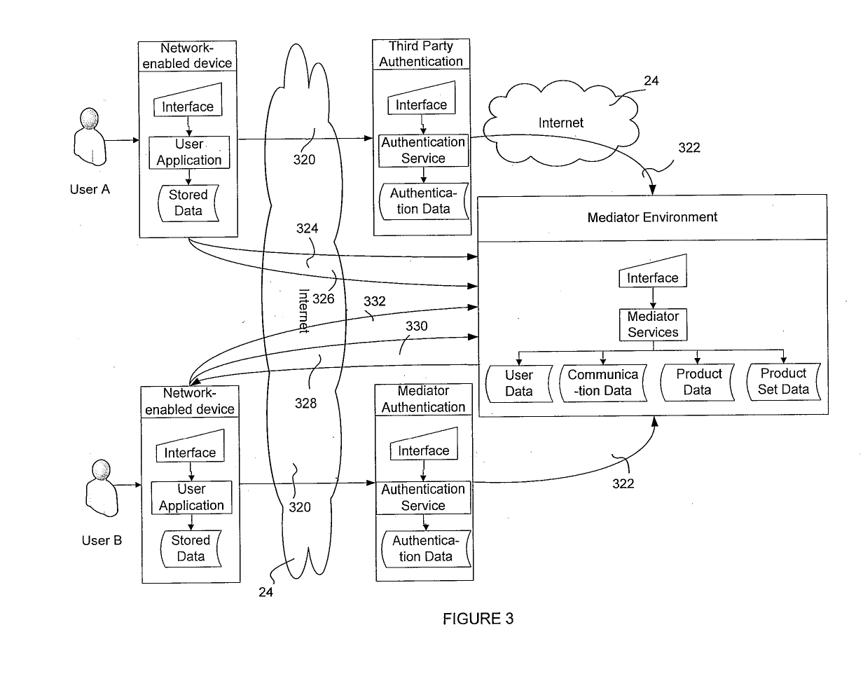

With reference to FIG. 3, there is shown a second diagram of a system for enabling a user to shop with at least one other user on a data network. In step 320, user A & B get authenticated. User A provides his membership credentials to an authentication service. The authentication service verifies the user's credentials.

In step 322, User A & B's sessions are validated. The authentication party opens a session for its user and validates the session with the mediator's environment.

In step 324, User A creates and manipulates a set of products. User A selects a set of one product or more. User A can manipulate the set of products. These manipulations can take the form of: classification of the products, placing the products in the two or three-dimensional environment, or tagging the products. User A can save a set of products for a later access. The mediator's environment may or may not provide the user the means to save the history of these manipulations.

In step 326, User A shares a set of products. User A can share his set of products with one or more members. He sends the set information to the selected members.

In step 328, User B receives notification of a shared set. If User A is allowed to contact User B, the later will receive a notification that the former has sent him a set of products. With the notification comes a mean to view the set.

In step 330, User B views and modifies the product set. User B views the set. He can modify the set to create a new one or save it for later use.

In step 332, User B shares. User B can reply to User A with the new set or he can, as in 326, share the new set with one or more member.

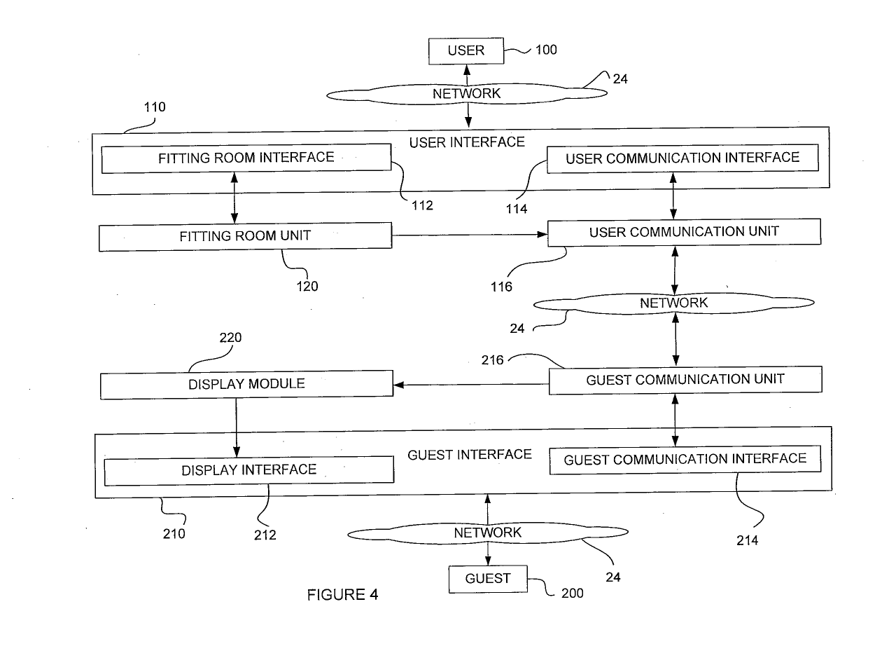

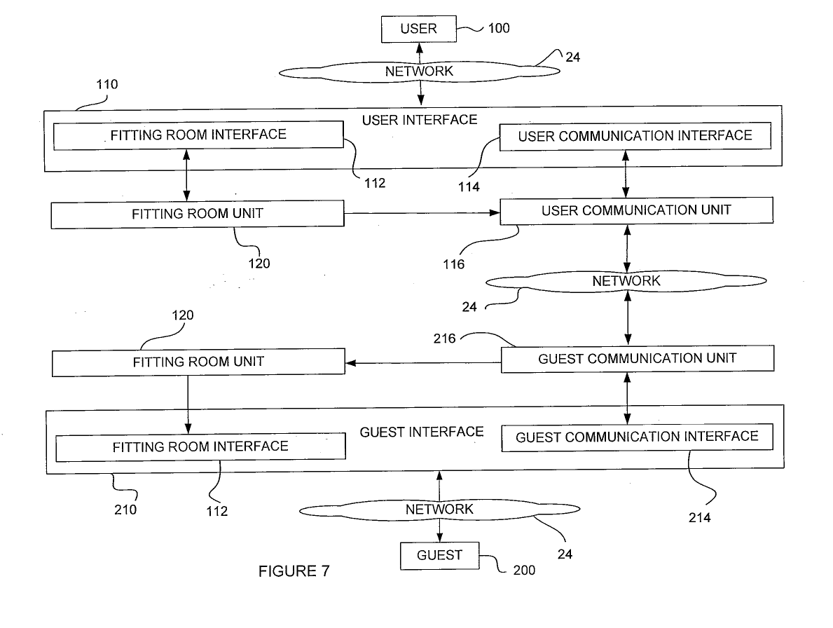

With reference to FIG. 4, there is provided a first embodiment of a system for enabling a user to shop with at least one other user over a data network. The system comprises a user interface 110 accessible to the user 100 via the network 24 and a guest interface 210 accessible to the at least one other user (or guest) 200 via the network 24. The user interface comprises a fitting room interface 112 and a user communication interface 114, whereas the guest interface comprises a guest communication interface 214 and a display interface 212. The system further comprises a fitting room unit 120 connected to the fitting room interface 112, a user communication unit 116 connected to the user communication interface 114, a guest communication unit 216 connected to the guest communication interface 214, and a guest display module 220 connected to the guest display interface 212. According to a second embodiment of the invention as illustrated in FIG. 7, there is provided a fitting room unit 120 and a fitting room interface 112 on the guest's side in order to enable the at least one other user to edit the set received from the user.

The user interface 110 is provided for enabling a user to shop with at least one other user over a data network, the user interface comprising a fitting room interface 112 with fitting room tools for enabling the user to conceive a set of at least one item of interest and a communication interface 114 with communication tools for enabling the user to share the set with at least one other user and to communicate therewith via the data network in order to shop the set of at least one item.

In one embodiment, the fitting room tools comprise an item insertion tool for enabling the user to insert the at least one item into the fitting room interface. The fitting room tools can further comprise item management tools for enabling the user to carry out at least one of spatially organizing and logically organizing the at least one item. It can also comprise a storing tool for enabling the user to store the conceived set in an item set database connected to the fitting room interface. A send to friend tool is also provided for enabling the user to provide the at least one other user access to the set of at least one item.

In a preferred embodiment, the communication tools comprise a communication session activation tool for enabling the user to initiate an interactive communication session with the at least one other user via the data network.

The fitting room unit 120 is adapted to be connected to the data network 24 for enabling the user 100 to conceive a set of at least one item of interest via the data network 24, and the user communication unit 116 is adapted to be connected to the fitting room unit 120 and to the data network 24 for enabling the user 100 to share the conceived set with at least one other user 200 and to interactively communicate therewith via the data network 24 in order to shop the set of at least one item.

The guest communication unit 214 is connected to the guest communication interface 214 and to the data network 24 for enabling the at least one other user 200 to receive access information associated with the conceived set of at least one item and to interactively communicate with the user via the data network 24 in order to shop the set.

According to a first embodiment, there is provided a guest display module 220 connected to the guest communication unit 216 and to the display interface 212 for receiving the access information and displaying the set to the at least one other user 200 via the display interface 212 (see FIG. 4). According to a second embodiment of the invention, there is provided a fitting room unit 120 connected to a fitting room interface 112 on the guest's side in order to enable the at least one other user to edit the received set (see FIG. 7).

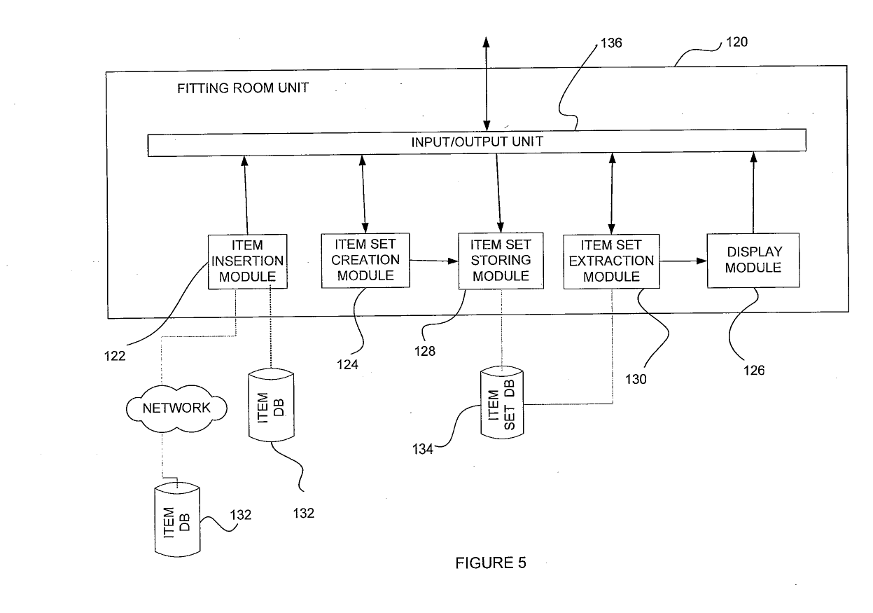

According to a preferred embodiment and as illustrated in FIG. 5, the fitting room unit comprises a first input/output unit 136, an item insertion module 122, an item set creation module 124, an item set storing module 128, an item set extraction module 130 and a display module 126.

The first input/output unit 136 is connected to the user fitting room interface 112 and to the data network 24 for inputting and outputting data from and to the various modules.

The item insertion module 122 is connected to the first input/output unit 136 and to an item database 132 for inserting the at least one item into the fitting room interface 112. The inserting process can consist of selecting the at least one item from an electronic market database connected locally to the insertion module or remotely via the data network 24 or uploading the at least one item from a personal storing device connected to the data network 24.

The item set creation module 124 is connected to the first input/output unit 136 for receiving the at least one item of interest inserted by the user 100 and for managing the at least one item according to user parameters defined thereby using the fitting room interface 112, where the managing comprises at least one of spatially organizing the at least one item within the fitting room interface 112 and logically organizing the at least one item using features of the fitting room interface 112.

The item set storing module 128 is connected to the item set creation module 124, to the first input/output interface 136 and to an item set database 134 for storing the conceived set in the item set database 134.

The item set extraction module 130 is connected to the first input/output interface 136, to the display module 126 and to the item set database 134 for extracting thereof set related information associated with a previously stored set.

The display module 126 is connected to the item set creation module 124, to the extraction module 130 and to the first input/output unit 136 for displaying the conceived set of at least one item to the user 100.

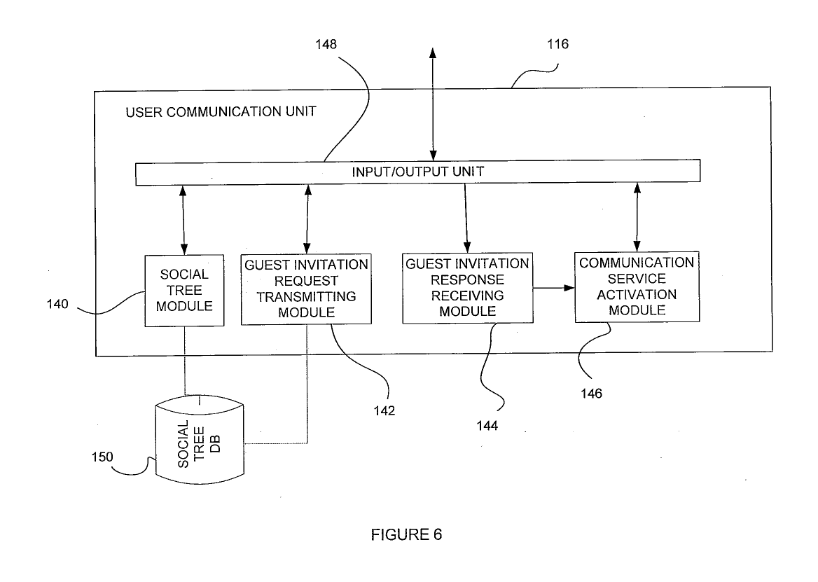

According to the preferred embodiment and as illustrated in FIG. 6, the user communication unit comprises a second input/output unit 148, a guest invitation request-transmitting module 142, a guest invitation response receiving module 144 and a communication service activation module 146.

The second input/output unit 148 is connected to the user communication interface 114 and to the data network 24.

The guest invitation request transmitting module 142 is connected to the second input/output unit 148 for transmitting an invitation request to each one of the at least one other user 200 inviting them to establish an interactive communication session with the user 100.

The guest invitation response receiving module 144 is connected to the second input/output unit 148 for receiving a response from the at least one other user 200 accepting or refusing the invitation.

The communication service activation module 146 is connected to the guest invitation response receiving module 144 and to the second input/output unit 148 for activating an interactive communication session between the user 100 and each one of the at least one other user 200 having accepted the invitation.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted that the present embodiments can be carried out as a method, can be embodied in a system, a computer readable medium or an electrical or electro-magnetical signal.

The embodiment(s) described above is (are) intended to be exemplary only. The scope of the invention is therefore intended to be limited solely by the scope of the appended claims.

1. A method for enabling a user to shop with at least one other user over a data network, the method comprising:
providing access to a user interface enabling said user to conceive a set of at least one item of interest, to share said set with at least one other user via said data network, and to communicate with said at least one other user via said data network to thereby shop said set.

2. The method as claimed in claim 2, wherein said user interface comprises a communication interface and said enabling said user to communicate with said at least one other user comprises enabling said user to initiate an interactive communication session with said at least one other user and to interactively communicate therewith using said communication interface.

3. The method as claimed in claim 2, wherein said sharing and said communication with said at least one other user are carried out concurrently by said user.

4. The method as claimed in claim 2, wherein said user interface further comprises a fitting room interface and said enabling said user to conceive a set of at least one item of interest comprises enabling said user to insert and manage said at least one item using said fitting room interface.

5. The method as claimed in claim 4, wherein said enabling said user to insert at least one item comprises at least one of enabling said user to select said at least one item from an electronic market database connected to said data network and enabling said user to upload said at least one item from a personal storing device connected to said data network.

6. The method as claimed in claim 5, wherein said enabling said user to manage said at least one item comprises at least one of enabling said user to spatially organize said at least one item within said fitting room interface and enabling said user to logically organize said at least one item using features of said fitting room interface.

7. The method as claimed in claim 6, wherein said enabling said user to share said set with at least one other user comprises storing data associated with said set in an item set database connected to said data network and providing said at least one other user access information allowing for accessing, via said data network, said set related data stored in said item set database.

8. The method as claimed in claim 6, wherein said enabling said user to share said set with at least one other user comprises enabling said user to create a file embodying a visual representation of said set and to transmit said created file to said at least one other user via said data network.

9. The method as claimed in claim 6, wherein said communication interface is adapted to receive at least one of data input and voice input.

10. The method as claimed in claim 9, wherein said enabling said user to initiate an interactive communication session comprises enabling said user to transmit an invitation request to said at least one other user using said communication interface, where said communication session is automatically established upon reception of an invitation acceptance signal thereof.

11. The method as claimed in claim 10, wherein said invitation request comprises information allowing to establish a communication link between said at least one other user and said user via said data network.

12. A user interface for enabling a user to shop with at least one other user over a data network, said user interface comprising a fitting room interface with fitting room tools for enabling said user to conceive a set of at least one item of interest and a communication interface with communication tools for enabling said user to share said set with at least one other user and to communicate therewith via said data network in order to shop said set of at least one item.

13. The user interface as claimed in claim 12, wherein said fitting room tools comprise an item insertion tool for enabling said user to insert said at least one item into said fitting room interface.

14. The user interface as claimed in claim 13, wherein said fitting room tools further comprise item management tools for enabling said user to carry out at least one of spatially organizing and logically organizing said at least one item.

15. The user interface as claimed in claim 14, wherein said fitting room tools further comprise a storing tool for enabling said user to store said conceived set in an item set database connected to said fitting room interface.

16. The user interface as claimed in claim 15, wherein said fitting room tools further comprise a send to friend tool for enabling said user to provide said at least one other user access to said set of at least one item.

17. The user interface as claimed in claim 16, wherein said communication tools comprise a communication session activation tool for enabling said user to initiate an interactive communication session with said at least one other user via said data network.

18. A system for enabling a user to shop with at least one other user over a data network, the system comprising:
a fitting room unit adapted to be connected to said data network for enabling said user to conceive a set of at least one item of interest via said data network; and
a user communication unit adapted to be connected to said fitting room unit and to said data network for enabling said user to share said conceived set with at least one other user and to interactively communicate therewith via said data network in order to shop said set of at least one item.

19. The system as claimed in claim 18, wherein said fitting room unit comprises:
A first input/output unit adapted to be connected to a user fitting room interface and to said data network;
an item insertion module connected to said first input/output unit and adapted to be connected to an item database for inserting said at least one item into said fitting room interface, where said inserting comprises at least one of selecting said at least one item from an electronic market database connected to said data network and uploading said at least one item from a personal storing device connected to said data network;
an item set creation module connected to said first input/output unit for receiving said at least one item of interest inserted by said user and for managing said at least one item according to user parameters defined thereby using said fitting room interface, where said managing comprises at least one of spatially organizing said at least one item within said fitting room interface and logically organizing said at least one item using features of said fitting room interface; and
a display module connected to said item creation module and to said first input/output unit for displaying said conceived set of at least one item to said user.

20. The system as claimed in claim 19, wherein said user communication unit comprises:
a second input/output unit adapted to be connected to a user communication interface and to said data network;
a guest invitation request transmitting module connected to said second input/output unit for transmitting an invitation request to each one of said at least one other user inviting to establish an interactive communication session with said user;
a guest invitation response receiving module connected to said second input/output unit for receiving a response from said at least one other user accepting or refusing said invitation; and
a communication service activation module connected to said guest invitation response receiving module and to said second input/output unit for activating an interactive communication session between said user and each one of said at least one other user having accepted said invitation.

21. The system as claimed in claim 20, wherein said fitting room unit further comprises:
an item set storing module connected to said item set creation module, to said first input/output interface and to an item set database for storing said conceived set in an item set database;
an item set extraction module connected to said first input/output interface, to said display module and to said item set database for extracting thereof set related information associated with a previously stored set.

22. The system as claimed in claim 18, further comprising:
a guest communication unit adapted to be connected to a guest communication interface and to said data network for enabling said at least one other user to receive access information associated with said conceived set of at least one item and to interactively communicate with said user via said data network in order to shop said set;
a display module adapted to be connected to said guest communication unit and to a display interface for receiving said access information and displaying said set to said at least one other user via said display interface.

23. The system as claimed in claim 22, further comprising a fitting room unit adapted to be connected to said data network for enabling said at least one other user to edit said received set of at least one item in order to transmit it to said user using said communication unit.
